(19) United States
(12) Patent Application Publication
(10) Pub. No.: US 2015/0293406 A1
(43) Pub. Date: Oct. 15, 2015

(54) Single-Layered Biaxial Compensation Structure For Liquid Crystal Panels And The Liquid Crystal Displays

(71) Applicants: Chih-tsung Kang, Shenzhen (CN); Bo Hai, Shenzhen (CN)

(72) Inventors: Chih-tsung Kang, Shenzhen (CN); Bo Hai, Shenzhen (CN)

(73) Assignee: Shenzhen China Star Optoelectronics Technology Co., Shenzhen, Guangdong (CN)

(21) Appl. No.: 14/358,321

(22) PCT Filed: Apr. 11, 2014
(86) PCT No.: PCT/CN2014/075146

§ 371 Date: May 15, 2014

(51) Int. Cl. G02F 1/13363; G02F 1/1335

(52) U.S. Cl. CPC G02F 1/133634; G02F 1/133528; G02F 1/133602; G02F 2001/133638; G02F 2413/05; G02F 2413/12

(57) ABSTRACT

A single-layered biaxial compensation structure including a first protection film, a first polarizing film, a biaxial compensation film, a liquid crystal panel, a second protection film, a second polarizing film and a third protection film arranged in sequence is disclosed. The liquid crystal panel includes a liquid crystal layer. An anisotropy reflective index of the liquid crystal layer is Δn, the thickness of the liquid crystal layer is d, a pretilt angle of the liquid crystal molecules is θ, an in-plane retardation value and a thickness retardation value of the biaxial compensation film are respectively Ro1 and Rth1, and the thickness retardation value of the second protection film is Rth2. Wherein: 287.3 nm ≦Δn×d ≦305.7 nm; 85°≦θ<90°; 45 nm ≦Ro1 ≦84 nm; 152 nm ≦Rth1 ≦280 nm; Y1 nm ≦Rth2 ≦Y2 nm; Y1=0.009107×(Rth1)² −4.67862×Rth1 +599.4; and Y2=−0.00869×(Rth1)²+2.7425×Rth1 −80.4.

### BACKGROUND OF THE INVENTION

1. Field Of The Invention

The present disclosure relates to liquid crystal display technology, and more particularly to a single-layered biaxial compensation structure for liquid crystal panels and the liquid crystal displays (LCDs) with the same. 2. Discussion Of The Related Art

LCDs are flat and thin display devices including a plurality of colorful or black pixels arranged in front of a light source or a reflective surface. In addition to the low power consumption, the LCDs also characterized by attributes including high display performance, small dimension, and light weight, and thus have become the main stream of the display devices. Currently, thin film transistor (TFT) LCD is the most popular one.

With the increasing dimension of TFT-LCD, the viewing angle also increases, which results in the decreasing contrast and resolution. This is mainly due to the changed birefringence index of the liquid crystal molecules. It is known that the brightness may greatly decreased when the viewing angle equals to a specific value. The viewing angle for traditional LCD usually equals to 90 degrees, that is, 45 degrees for both the right side and the left side. The linear liquid crystal for manufacturing the liquid crystal panel is the material with birefringence index An. When passing through the liquid crystal molecules, the light beams may be divided into ordinary rays and extraordinary rays. If the light beams oblique incidents on the liquid crystal molecules, two reflective light beams are generated. The birefringence index Δn=ne−no, where “ne” represents the reflective index of the liquid crystal molecules relating to ordinary light beams and “no” represents the reflective index of the liquid crystal molecules relating to non-ordinary light beams. Thus, when the light beams pass through the liquid crystal molecules between the two glasses, phase retardation occurs. The optical characteristics of the liquid crystal cell is usually evaluated by the phase retardation, i.e., Δn×d, which is usually called as the optical path difference, where Δn represents the birefringence index and d represents the thickness of the liquid crystal cell. The above mentioned problem is caused by the different phase retardation in different viewing angles. The phase retardation of good optical compensation film may offset that of the linear liquid crystal molecules so as to increase the visible angle of the liquid crystal panel. The compensation principle of the optical compensation film relates to alter the phase difference resulting from different viewing angles. In this way, the birefringence liquid crystal molecules can be compensated symmetrically. By adopting the optical compensation film, the dark-state light leakage may be greatly reduced, and the contrast can also be greatly enhanced within a certain viewing angle. The optical compensation film includes retardation films, compensation films, wide view films, and so on. The optical compensation film can reduce the light leakage amount in the dark-state. In addition, the contrast and color saturation can be greatly enhanced, and some inversed gray scale issue can be overcome. The parameters for evaluating the optical compensation film includes an in-plane delay Ro, a thickness direction delay Rth, a refractive rate N, and a film thickness D. The following equations are satisfied:

Ro=(Nx−Ny)×D;

Rth=[(Nx+Ny)/2−Nz]×D;

Wherein, Nx is a refractive index along the slow axis in the plane of the film (having a maximum refractive index axis, i.e., light having a slower velocity of propagation of the vibration direction), Ny is a refractive index along a fast axis in the plane of the film (having a minimum refractive index axis, that is, light having a vibration direction of the fast propagation rate, perpendicular to Nx), and Nz is a refractive index in the plane of the film (perpendicular to Nx and Ny).

Different optical compensation films are adopted for different display modes, i.e., liquid crystal cells. Also, the values of Ro and Rth have to be configured accordingly. Currently, the optical compensation films adopted by the large-scale LCDs focus on the vertical alignment (VA) display mode. In the past, the optical compensation films, including N-TAC developed by Konica, Zeonor developed by OPTES, F-TAC developed by Fujitsu, and X-plate developed by Nitto Denko are adopted in sequence.

FIG. 1 is a diagram depicting the dark-state brightness distribution at all viewing angles of one conventional single-layered biaxial compensation film after being compensated.

FIG. 2 is a diagram depicting the dark-state contrast distribution at all viewing angles of the liquid crystal panel of FIG. 1. The optical path difference Δn×d=296.5 nm. The in-plane retardation value and a thickness retardation value of the single-layered biaxial compensation film are respectively 72 nm and 240 nm. It can be seen from FIGS. 1 and 2 that under the above conditions, light leakage occurs in several areas after being compensated by the conventional compensation film, and the visible range is smaller.

### SUMMARY

To overcome the above problem, the single-layered biaxial compensation film for the liquid crystal panels is capable of greatly reducing the dark-state light leakage by configuring the retardation values for the liquid crystal panel. In addition, the contrast and the resolution in wide viewing angle can be enhanced.

In one aspect, a single-layered biaxial compensation structure includes: a first protection film, a first polarizing film, a biaxial compensation film, a liquid crystal panel, a second protection film, a second polarizing film and a third protection film arranged in sequence, wherein the liquid crystal panel comprises a liquid crystal layer having a plurality of liquid crystal molecules, an anisotropy reflective index of the liquid crystal layer is Δn, the thickness of the liquid crystal layer is d, a pretilt angle of the liquid crystal molecules is θ, an in-plane retardation value and a thickness retardation value of the biaxial compensation film are respectively Ro1 and Rth1, the thickness retardation value of the second protection film is Rth2, wherein: 287.3 nm ≦Δn×d ≦305.7 nm; 85°≦θ<90°; 45 nm ≦Ro1≦84 nm; 152 nm ≦Rth1≦280 nm; Y1 nm ≦Rth2≦Y2 nm; Y1=0.009107×(Rth1)²−4.67862×Rth1+599.4; and Y2=−0.00869×(Rth1)2 +2.7425×Rth1 -80.4.

Wherein 290 nm ≦Δn×d ≦303 nm.

Wherein Y1 equals to 17.7, and Y2 equals to 67.9.

Wherein the thickness retardation value of the second protection film Rth2 equals to 47.2 nm.

Wherein the first polarizing film and the second polarizing film are made by Polyvinyl alcohol (PVA)

Wherein the first protection film, the second protection film, and the third protection film are made by Triacetyl Cellulose (TAC).

Wherein an included angle between a light absorbing axis of the first polarizing film and a slow axis of the biaxial compensation film is 90 degrees.

Wherein the liquid crystal panel is a vertical alignment mode.

In another aspect, a liquid crystal device includes: a liquid crystal display panel and a backlight module arranged opposite to the liquid crystal display panel, the backlight module provides a light source to the liquid crystal display panel such that the liquid crystal display panel is capable of displaying images, the liquid crystal display panel adopts the above single-layered biaxial compensation structure.

In view of the above, the single-layered biaxial compensation film for the liquid crystal panel is capable of greatly reducing the dark-state light leakage by configuring the retardation values for the second protection film. The contrast and the resolution at wide viewing angle can be enhanced. Compensation by the single-layered biaxial compensation film and the second protection layer not only overcome the issue causing by the single-layered biaxial compensation film, but also can reduce the cost relating to the dual-layered biaxial compensation film.

### BRIEF DESCRIPTION OF THE DRAWINGS

FIG. 1 is a diagram depicting the dark-state brightness distribution at all viewing angles of one conventional single-layered biaxial compensation structure after being compensated.

FIG. 2 is a diagram depicting the dark-state contrast distribution at all viewing angles of the liquid crystal panel of FIG. 1.

FIG. 3 is a schematic view showing the liquid crystal device in accordance with one embodiment.

FIG. 4 is a schematic view showing the single-layered biaxial compensation structure in accordance with one embodiment.

FIG. 5 is a trend diagram showing the relationship between the dark-state light leakage and the retardation values when the optical path difference is 287.3 nm and the pretile angle is 89 degrees in accordance with one embodiment.

FIG. 6 is a trend diagram showing the relationship between the dark-state light leakage and the retardation values when the optical path difference is 290 nm in accordance with one embodiment.

FIG. 7 is a trend diagram showing the relationship between the dark-state light leakage and the retardation values when the optical path difference is 303 nm in accordance with one embodiment.

FIG. 8 is a trend diagram showing the relationship between the dark-state light leakage and the retardation values where the optical path difference is 305.7 nm in accordance with one embodiment.

FIG. 9 is a diagram depicting the dark-state brightness distribution at all viewing angles of the liquid crystal panel after being compensated in accordance with one embodiment.

FIG. 10 is a diagram depicting the dark-state contrast distribution at all viewing angles of the liquid crystal panel of FIG. 9.

FIG. 11 is a diagram depicting the dark-state brightness distribution at all viewing angles of the liquid crystal panel after being compensated in accordance with another embodiment.

FIG. 12 is a diagram depicting the dark-state contrast distribution at all viewing angles of the liquid crystal panel of FIG. 11.

FIG. 13 is a diagram depicting the dark-state brightness distribution at all viewing angles of the liquid crystal panel after being compensated in accordance with another embodiment.

FIG. 14 is a diagram depicting the dark-state contrast distribution at all viewing angles of the liquid crystal panel of FIG. 13.

### DETAILED DESCRIPTION OF THE EMBODIMENTS

Embodiments of the invention will now be described more fully hereinafter with reference to the accompanying drawings, in which embodiments of the invention are shown.

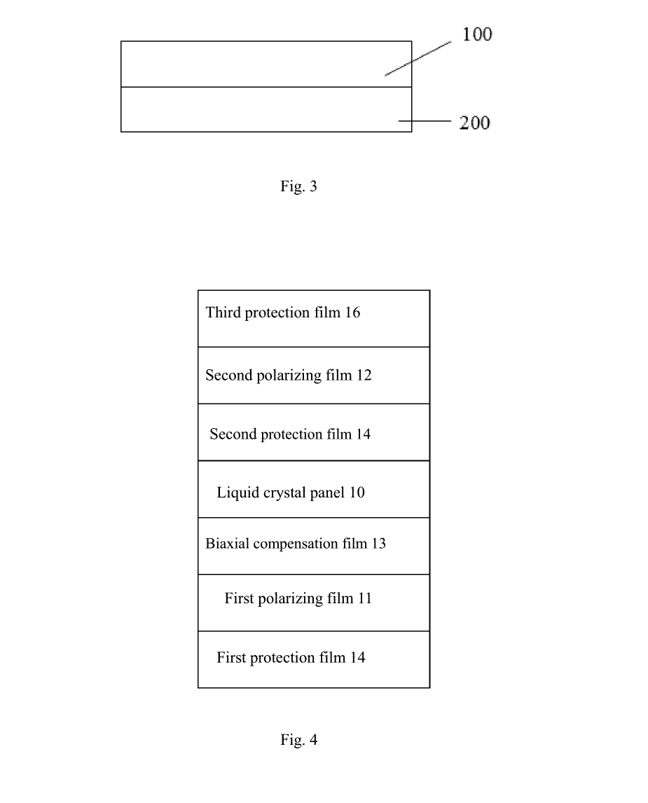

Referring to FIG. 3, the LCD includes a liquid crystal display panel 100 and a backlight module 200 arranged opposite to the liquid crystal display panel 100. The backlight module 200 provides a light source to the liquid crystal display panel 100 such that the liquid crystal display panel 100 can display images. The liquid crystal display panel 100 is the liquid crystal panel adopting a single-layered biaxial compensation structure.

FIG. 4 shows the single-layered biaxial compensation structure including a first protection film 14, a first polarizing film 11, a biaxial compensation film 13, a liquid crystal panel 10, a second protection film 15, and a second polarizing film 12, and a third protection film 16 arranged in sequence from bottom to up. In other embodiments, the above components may be arranged in an reversed sequence. The liquid crystal panel 10 is a VA liquid crystal cell (VA cell). The first polarizing film 11 and the second polarizing film 12 are made by Polyvinyl alcohol (PVA). An included angle between a light absorbing axis of the first polarizing film 11 and a slow axis of the biaxial compensation film 13 is configured to be 90 degrees. The first protection film 14, the second protection film 15, and the third protection film 16 are made by Triacetyl Cellulose (TAC). The TAC protection films 14, 15, and 16 are for protecting the first PVA polarizing film 11 and the second PVA polarizing film 12, for enhancing the mechanical functions of the first PVA polarizing film 11 and the second PVA polarizing film 12, and for preventing the first PVA polarizing film 11 and the second PVA polarizing film 12 from retraction.

The liquid crystal panel 10 includes a liquid crystal layer having a plurality of liquid crystal molecules. The anisotropy reflective index of the liquid crystal layer is Δn, the thickness of the liquid crystal layer is d, and the pretilt angle of the liquid crystal molecules is θ. In the above example, the in-plane retardation value of the biaxial compensation film 13 is Ro1, and the thickness retardation is Rth1, and the thickness retardation value of the second protection film 15 is Rth2.

The above structure relates to configuring appropriate the retardation values of the biaxial compensation film 13 and the second protection film 15 so as to reduce the light leakage of the liquid crystal panels, which also contributes to the contrast and the resolution at wide viewing angle.

The following configurations are adopted in related simulations.

The liquid crystal layer is configured as below.

1. The pretile angle θ: 85°≦θ<90° ;

2. The pretile angles for four dimensions are respectively 45, 135, 225, 315 degrees; and

3. The optical path difference Δx×d : 287.3nm ≦Δn×d ≦305.7nm.

The backlight source is configured as below:

1. Light source: Blue-YAG LED optical spectrum;

2. The central brightness of the light source is 100 nit; and

3. The light source distribution is Lambert's distribution.

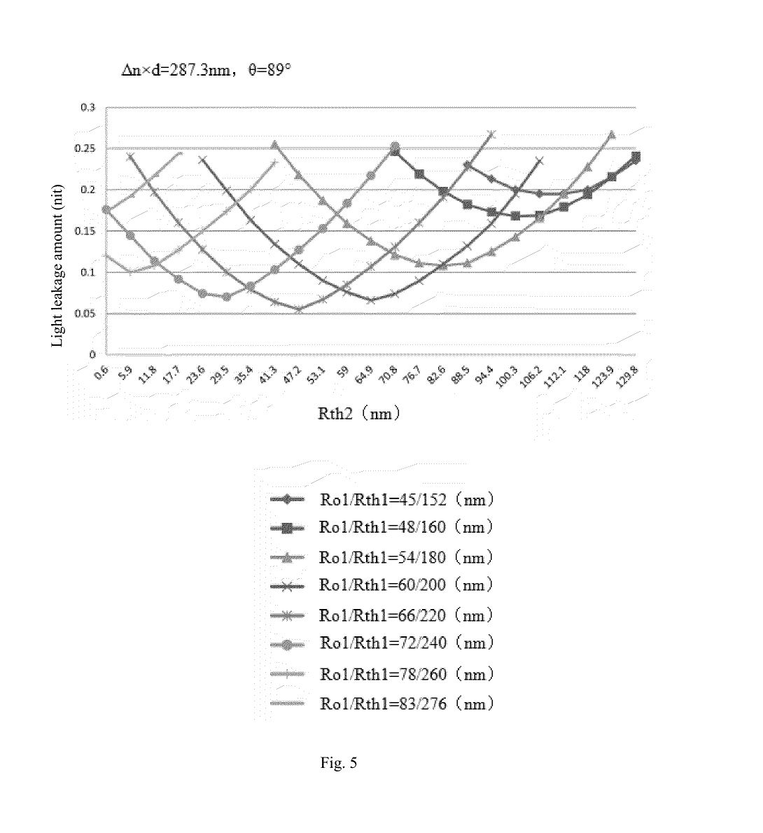

FIG. 5 is a trend diagram showing the relationship between the dark-state light leakage and the retardation values when the optical path difference is 287.3 nm and the pretile angle is 89 degrees in accordance with one embodiment.

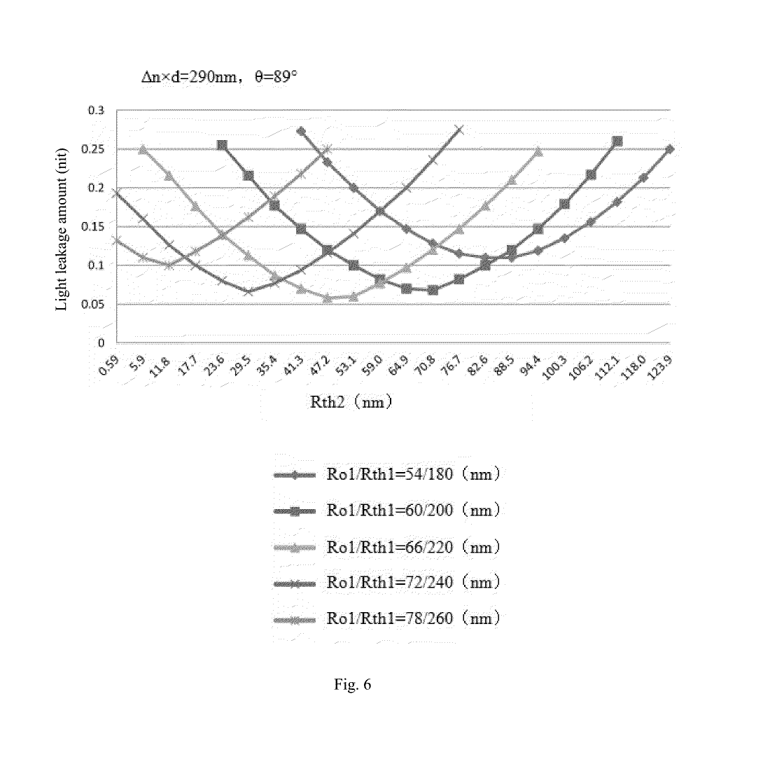

FIG. 6 is a trend diagram showing the relationship between the dark-state light leakage and the retardation values when the optical path difference is 290 nm and pretile angle is 89 degrees in accordance with one embodiment.

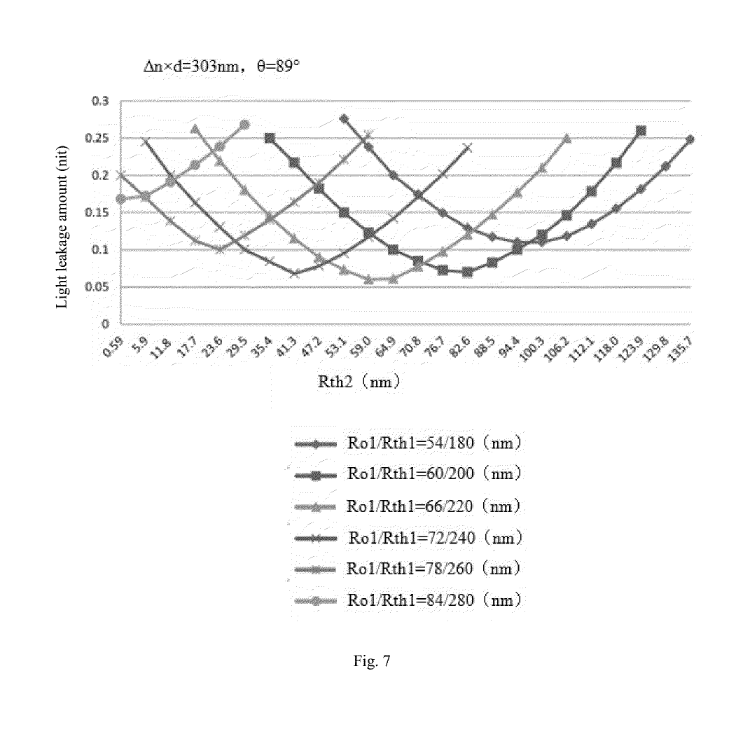

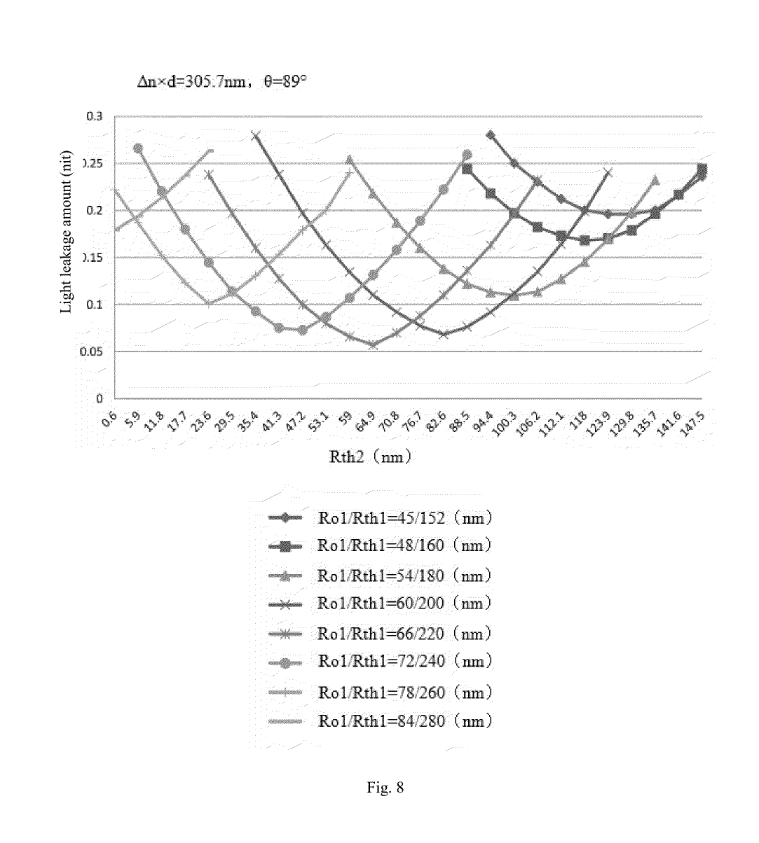

FIG. 7 is a trend diagram showing the relationship between the dark-state light leakage and the retardation values when the optical path difference is 303 nm and the pretilt angle is 89 degrees in accordance with one embodiment. FIG. 8 is a trend diagram showing the relationship between the dark-state light leakage and the retardation values where the optical path difference is 305.7 nm and the pretilt angle is 89 degrees in accordance with one embodiment. The simulations are conducted by combinations of different pretile angles and retardation values, and the conditions include: 287.3 nm ≦Δn×d ≦305.7 nm; 85°≦0<90°; and the dark-state light leakage is smaller than 0.2 nit. The corresponding ranges of the retardation values for the biaxial compensation film 13 and the second protection film 15 are: 45 nm ≦Ro1 ≦84 nm; 152 nm ≦Rth1 ≦280 nm; Y1 nm ≦Rth2 ≦Y2 nm; and wherein

Y1=0.009107×(Rth1)² −4.67862×Rth1 +599.4;

Y2=−0.00869×(Rth1)² +2.7425×Rth1 −80.4.

The retardation values of the compensation film, including Ro, Rth, the reflective index N and the thickness D, satisfy the equations below:

Ro=(Nx−Ny)×D;

Rth=[(Nx+Ny)/2−Nz]xD;

Thus, the retardation values may be changed by three methods.

1. The thickness D is changed while the reflective index N of the biaxial compensation film 13 and the second protection film 15 remain the same.

2. The reflective index N is changed while the thickness D of the biaxial compensation film 13 and the second protection film 15 remains the same.

3. The thickness D and the reflective index N are changed at the same time, but the ranges of the thickness retardation values of the biaxial compensation film 13 and the second protection film 15 are guaranteed.

Some of the retardation values are selected to test the compensation result so as to further describe the technical effects of the present disclosure.

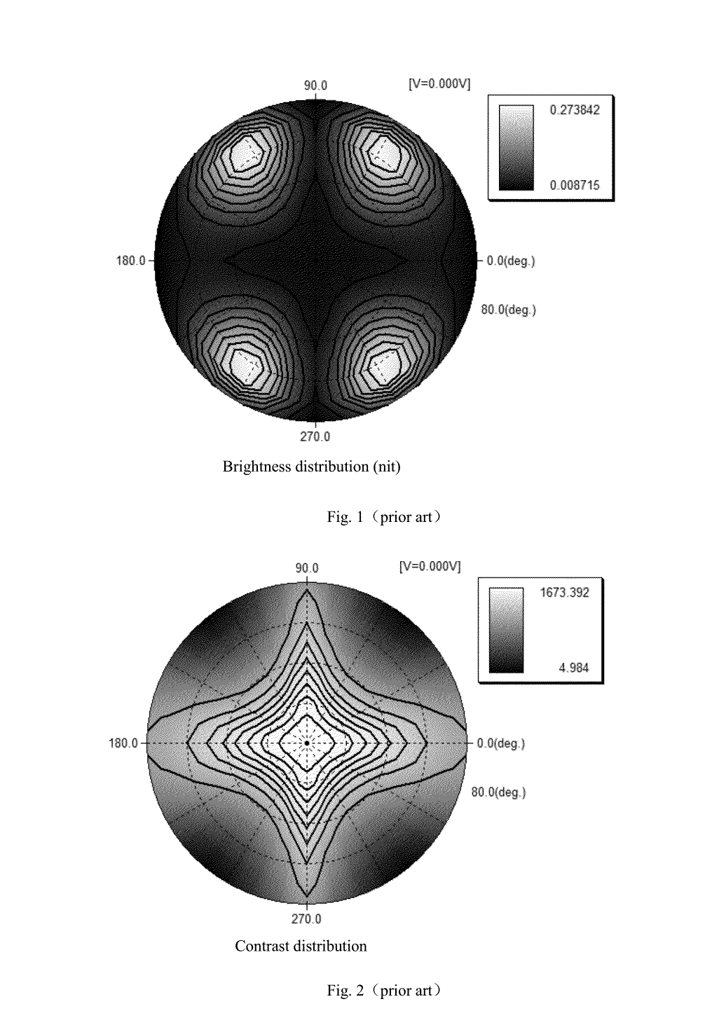

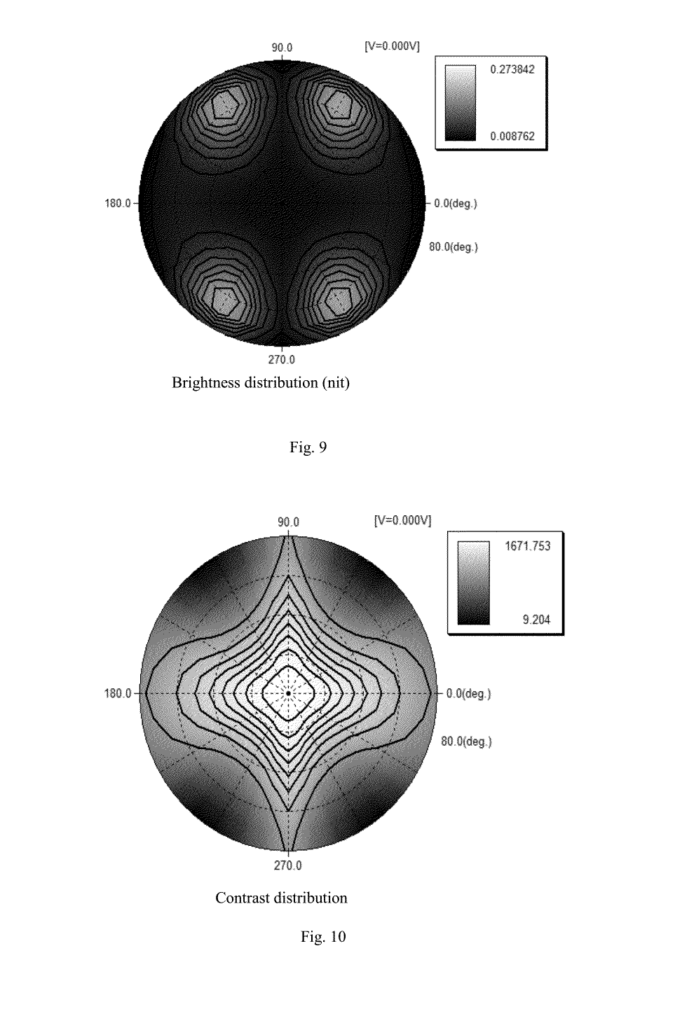

FIG. 9 is a diagram depicting the dark-state brightness distribution at all viewing angles of the liquid crystal panel after being compensated in accordance with one embodiment. FIG. 10 is a diagram depicting the dark-state contrast distribution at all viewing angles of the liquid crystal panel of FIG. 9. The conditions set for FIGS. 9 and 10 include: the optical path difference Δn×d=296.5 nm, the pretilt angle θ=89°, Ro=72 nm, Rth1=240 nm, Rth2=67.9 nm. Comparing FIG. 9 with FIG. 1, it can be seen that the dark-state light leakage of the compensation structure of FIG. 9 is much lower than that of FIG. 1. Comparing FIG. 10 with FIG. 2, it can be seen that the contrast distribution for all viewing angles of FIG. 8 is better than that of FIG. 2.

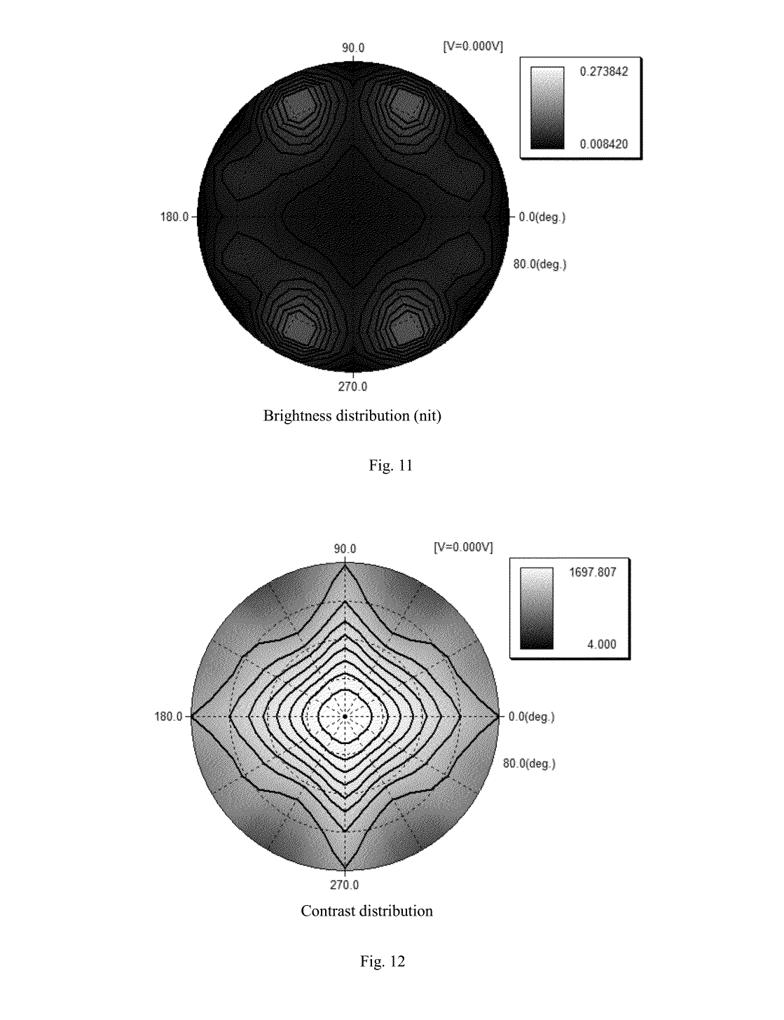

FIG. 11 is a diagram depicting the dark-state brightness distribution at all viewing angles of the liquid crystal panel after being compensated in accordance with another embodiment. FIG. 12 is a diagram depicting the dark-state contrast distribution at all viewing angles of the liquid crystal panel of FIG. 11. The conditions set for FIGS. 9 and 10 include: optical path difference Δn×d=296.5 nm, pretilt angle θ=89°, Ro=72 nm, Rth1=240 nm, and Rth2=47.2nm. Comparing FIG. 11 with FIG. 1, it can be seen that the dark-state light leakage of the compensation structure of FIG. 11 is much lower than that of FIG. 1. Comparing FIG. 12 with FIG. 2, it can be seen that the contrast distribution for all viewing angles of FIG. 10 is better than that of FIG. 2.

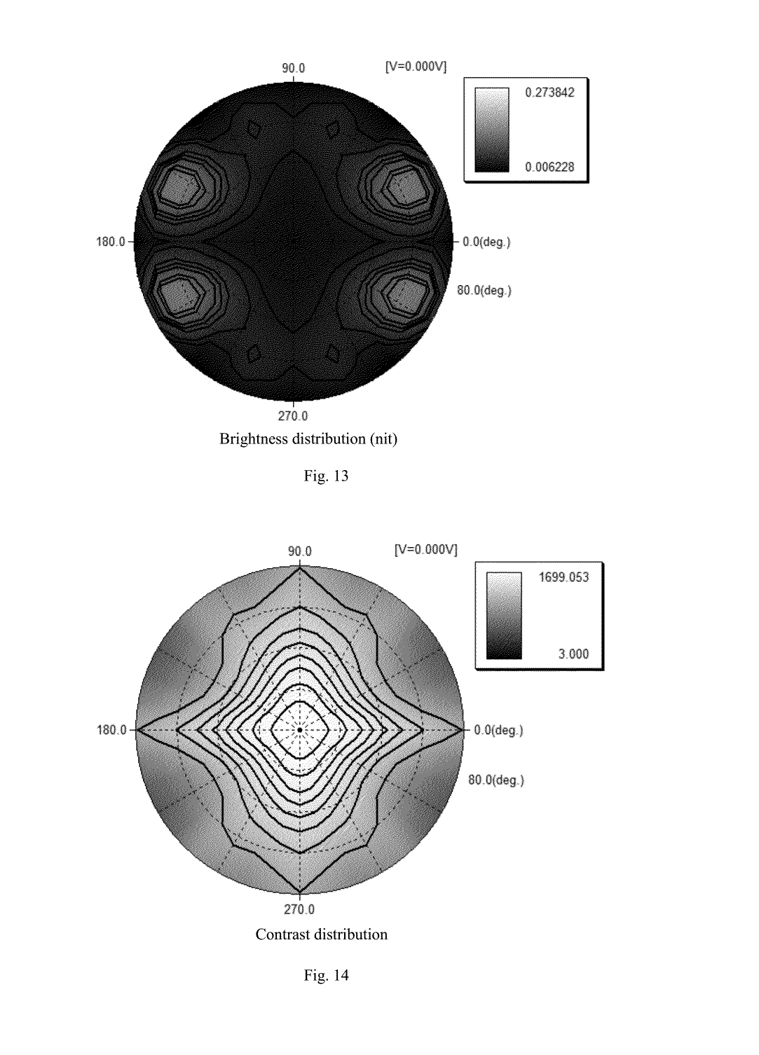

FIG. 13 is a diagram depicting the dark-state brightness distribution at all viewing angles of the liquid crystal panel after being compensated in accordance with another embodiment. FIG. 14 is a diagram depicting the dark-state contrast distribution at all viewing angles of the liquid crystal panel of FIG. 13. The conditions set for FIGS. 13 and 14 include: the optical path difference Δn×d=296.5 nm, the pretilt angle θ=89°, Ro=72 nm, Rth1 =240 nm, and Rth2=17.7 nm. Comparing FIG. 13 with FIG. 1, it can be seen that the dark-state light leakage of the compensation structure of FIG. 13 is much lower than that of FIG. 1. Comparing FIG. 12 with FIG. 2, it can be seen that the contrast distribution for all viewing angles of FIG. 12 is better than that of FIG. 2.

The values of the above parameters, including optical path difference Δn×d, pretilt angle 0 and Ro, and Rthl are only taken as examples for some embodiments. That is, the optical path difference Δn×d=296.5, the pretilt angle is 89 degrees, Ro=72 nm, and Rthl =240 nm. Comparing to the conventional compensation structure as shown in FIGS. 1 and 2, which only relates to changing the retardation value of Rth2, the above embodiments have achieved better technical effects. It is proved by the simulations that certain technical effects may be achieved while the parameters are selected within the following ranges: 287.3 nm ≦Δn×d ≦305.7 nm; 85°≦θ<89°; 45 nm ≦Ro1 <84 nm; 152 nm ≦Rth1 ≦280 nm; Y1 nm ≦Rth2 ≦Y2 nm; Y1=0.009107×(Rth1)² −4.67862×Rth1 +599.4; and Y2=−0.00869×(Rth1)² +2.7425×Rth1 −80.4.

In view of the above, the single-layered biaxial compensation film for the liquid crystal panel is capable of greatly reducing the dark-state light leakage by configuring the retardation values for the second protection film. The contrast and the resolution at wide viewing angle can be enhanced. Compensation by the single-layered biaxial compensation film and the second protection layer not only overcome the issue causing by the single-layered biaxial compensation film, but also can reduce the cost relating to the dual-layered biaxial compensation film.

It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A single-layered biaxial compensation structure, comprising:
a first protection film, a first polarizing film, a biaxial compensation film, a liquid crystal panel, a second protection film, a second polarizing film and a third protection film arranged in sequence, wherein the liquid crystal panel comprises a liquid crystal layer having a plurality of liquid crystal molecules, an anisotropy reflective index of the liquid crystal layer is An, the thickness of the liquid crystal layer is d, a pretilt angle of the liquid crystal molecules is 0, an in-plane retardation value and a thickness retardation value of the biaxial compensation film are respectively Rol and Rthl, the thickness retardation value of the second protection film is Rth2, wherein:
287. 3 nm ≦Δn×d ≦305.7 nm;
85°≦θ<90°;
45 nm ≦Ro1 ≦84 nm;
152 nm ≦Rth1 ≦280 nm;
Y1 nm ≦Rth2 ≦Y2 nm;
Y1=0.009107×(Rth1)² −4.67862×Rth1 +599.4; and
Y2=−0.00869×(Rth1)² +2.7425×Rth1 −80.4.

2. The single-layered biaxial compensation structure as claimed in claim 1, wherein 290 nm ≦Δn×d ≦303 nm.

3. The single-layered biaxial compensation structure as claimed in claim 1, wherein Y1 equals to 17.7, and Y2 equals to 67.9.

4. The single-layered biaxial compensation structure as claimed in claim 1, wherein the thickness retardation value of the second protection film Rth2 equals to 47.2 nm.

5. The single-layered biaxial compensation structure as claimed in claim 1, wherein the first polarizing film and the second polarizing film are made by Polyvinyl alcohol (PVA).

6. The single-layered biaxial compensation structure as claimed in claim 4, wherein the first protection film, the second protection film, and the third protection film are made by Triacetyl Cellulose (TAC).

7. The single-layered biaxial compensation structure as claimed in claim 5, wherein the first protection film, the second protection film, and the third protection film are made by Triacetyl Cellulose (TAC).

8. The single-layered biaxial compensation structure as claimed in claim 5, wherein an included angle between a light absorbing axis of the first polarizing film and a slow axis of the biaxial compensation film is 90 degrees.

9. The single-layered biaxial compensation structure as claimed in claim 7, wherein the liquid crystal panel is a vertical alignment mode.

10. The single-layered biaxial compensation structure as claimed in claim 8, wherein the liquid crystal panel is a vertical alignment mode.

11. A liquid crystal device, comprising:
a liquid crystal display panel and a backlight module arranged opposite to the liquid crystal display panel, the backlight module provides a light source to the liquid crystal display panel such that the liquid crystal display panel is capable of displaying images, the liquid crystal display panel adopts a single-layered biaxial compensation structure comprises:
a first protection film, a first polarizing film, a biaxial compensation film, a liquid crystal panel, a second protection film, a second polarizing film and a third protection film arranged in sequence, wherein the liquid crystal panel comprises a liquid crystal layer having a plurality of liquid crystal molecules, an anisotropy reflective index of the liquid crystal layer is Δn, the thickness of the liquid crystal layer is d, a pretilt angle of the liquid crystal molecules is θ, an in-plane retardation value and a thickness retardation value of the biaxial compensation film are respectively Ro1 and Rth1, the thickness retardation value of the second protection film is Rth2, wherein:
287. 3 nm ≦Δn×d ≦305.7 nm;
85°≦θ<90°;
45 nm ≦Ro1 ≦84 nm;
152 nm ≦Rth1 ≦280 nm;
Y1 nm ≦Rth2 ≦Y2 nm;
Y1=0.009107×(Rth1)² −4.67862×Rth1 +599.4; and
Y2=−0.00869×(Rth1)² +2.7425×Rth1 −80.4.

12. The liquid crystal device as claimed in claim 11, wherein 290 nm ≦Δn×d ≦303 nm.

13. The liquid crystal device as claimed in claim 11, wherein Y1 equals to 17.7, and Y2 equals to 67.9.

14. The liquid crystal device as claimed in claim 11, wherein the thickness retardation value of the second protection film Rth2 equals to 47.2 nm.

15. The liquid crystal device as claimed in claim 11, wherein the first polarizing film and the second polarizing film are made by PVA.

16. The liquid crystal device as claimed in claim 14, wherein the first protection film, the second protection film, and the third protection film are TAC.

17. The liquid crystal device as claimed in claim 15, wherein the first protection film, the second protection film, and the third protection film are made by TAC.

18. The liquid crystal device as claimed in claim 15, wherein an included angle between a light absorbing axis of the first polarizing film and a slow axis of the biaxial compensation film is 90 degrees.

19. The liquid crystal device as claimed in claim 17, wherein the liquid crystal panel is a vertical alignment mode.

20. The liquid crystal device as claimed in claim 18, wherein the liquid crystal panel is a vertical alignment mode.
